(19) United States
(12) Patent Application Publication
(10) Pub. No.: US 2009/0035097 A1
(43) Pub. Date: Feb. 5, 2009

(54) REMOTELY OPERATED MACHINE WITH MANIPULATOR ARM

(76) Inventor: Elgan Williams Loane, County Cork (IE)

Correspondence Address: GOTTLIEB RACKMAN & REISMAN PC, 270 MADISON AVENUE, 8TH FLOOR, NEW YORK, NY, 10016-0601, US

(21) Appl. No.: 12/093,211

(22) PCT Filed: Nov. 10, 2006
(86) PCT No.: PCT/GB06/04188

§ 371 Date: Sep. 18, 2008

(30) Foreign Application Priority Data
Nov. 10, 2005 (GB) 0522924.0

(51) Int. Cl. B25J 5/02; B25J 5/00

(52) U.S. Cl. 414/4; 414/1; 901/1

(57) ABSTRACT

A remotely operable machine (1) comprises a manipulator arm (17), a machine body (3), and a support (5). The support is disposed between the machine body and the manipulator arm for coupling the arm to the body. The support is movable from one position (D) to another (E) relative to said body so as to provide for variation or extension of the reach of the manipulator arm. The support may be provided by a linkage having an attachment (15) for pivotally supporting the arm, the attachment being pivotally coupled to an extension arm (19) at one end thereof, the extension arm being pivotally coupled to the machine body at its other end. Alternatively, a track assembly for facilitating movement of the support on the machine body may be provided. The track assembly or linkage are configured to allow deployment of the support on the ground adjacent to said body.

This invention relates to a remotely operated machine with a manipulator arm, such a machine particularly, but not exclusively being, suitable for deployment in the field of bomb disposal for dealing with suspect packages, unexploded ordnance and improvised explosive devices.

Known robotic machines of this type have a manipulator arm which is fixed to the body of the machine at an attachment point which itself is not movably adjustable relative to said body. As a result, the maximum reach and operational dexterity of the manipulator arm are limited and determined by the location of the attachment point.

An object of the invention is to provide a remotely operated machine with which this disadvantage can be alleviated. A further object is to provide a manipulator arm suitable for such a machine.

According to a first aspect of the present invention, there is provided a remotely operable machine comprising a manipulator arm, a machine body, and a support disposed between said machine body and said manipulator arm for coupling said arm to said body, wherein said support is movable from one position to another relative to said body so as to provide for variation or extension of the reach of the manipulator arm.

In a preferred embodiment of the present invention, the manipulator arm may be provided with a tool such as a gripping claw and/or sensing device at the end thereof remote from the support. The support may be configured to provide for movement of said manipulator arm in a horizontal plane about a vertical axis. The support may additionally provide for movement of said manipulator arm in a vertical plane about a horizontal axis. The manipulator arm may be provided with one or more articulations and/or telescopic sections that facilitate a radial degree of movement of the tool relative to the support. The movement of the arm about the vertical and horizontal axes together with the radial movement provides for variable positioning of the tool within three degrees of freedom.

In one embodiment, the support may comprise a linkage having an attachment for pivotally supporting the arm, the attachment being pivotally coupled to an extension arm at one end thereof, the extension arm being pivotally coupled to the machine body at its other end. A drive may be provided for rotating said extension arm relative to the pivot at the machine body such that the position of the end of the arm supported by the attachment can be deployed at selectable positions along an arc having a radius defined substantially by the length of the extension arm. The coupling position and configuration of the extension arm to the machine body may be such that the attachment may be positioned to rest on the ground adjacent to the machine body. A locking mechanism may be provided for securing the attachment for stability when the machine is parked so that the load manipulating capacity of the arm can be increased. A stabiliser may be provided for improving the load manipulating capacity when the attachment is deployed on the ground.

In an alternative embodiment, a track assembly may be provided for facilitating movement of the support on said body. The track assembly may be configured to allow deployment of the support on the ground adjacent to said body.

According to a second aspect of the invention, there is provided a manipulator arm for a remotely operable machine having a machine body, the manipulator arm having an attachment for facilitating coupling thereof to the machine body so that the manipulator arm is movable relative to the machine body in order to allow variation or extension of the reach of the arm.

According to a third aspect of the invention there is provided a body of a remotely operable machine, the body being configured to facilitate coupling thereto of a manipulator arm attachment such that said manipulator arm attachment is movable relative to said body in order that the reach of a manipulator arm coupled to said attachment can be varied or extended.

Embodiments of the present invention provide for one or more of the following advantages: improved horizontal reach and dexterity at ground level; improved horizontal reach and dexterity at intermediate heights; and increased vertical reach and dexterity above and below ground level.

The invention will now be further described by way of example with reference to the accompanying drawings, in which:

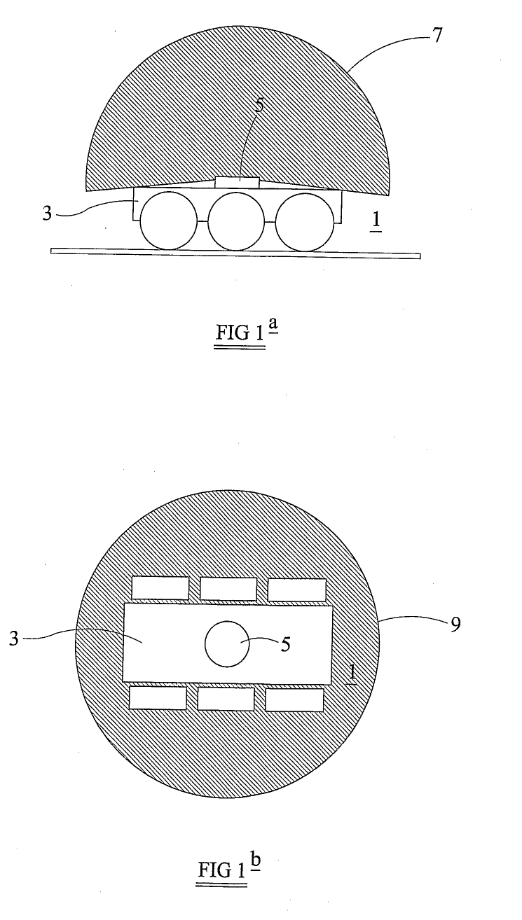

FIGS. 1a and 1b show the operating reach of a manipulator arm of a remotely operable machine according to the prior art;

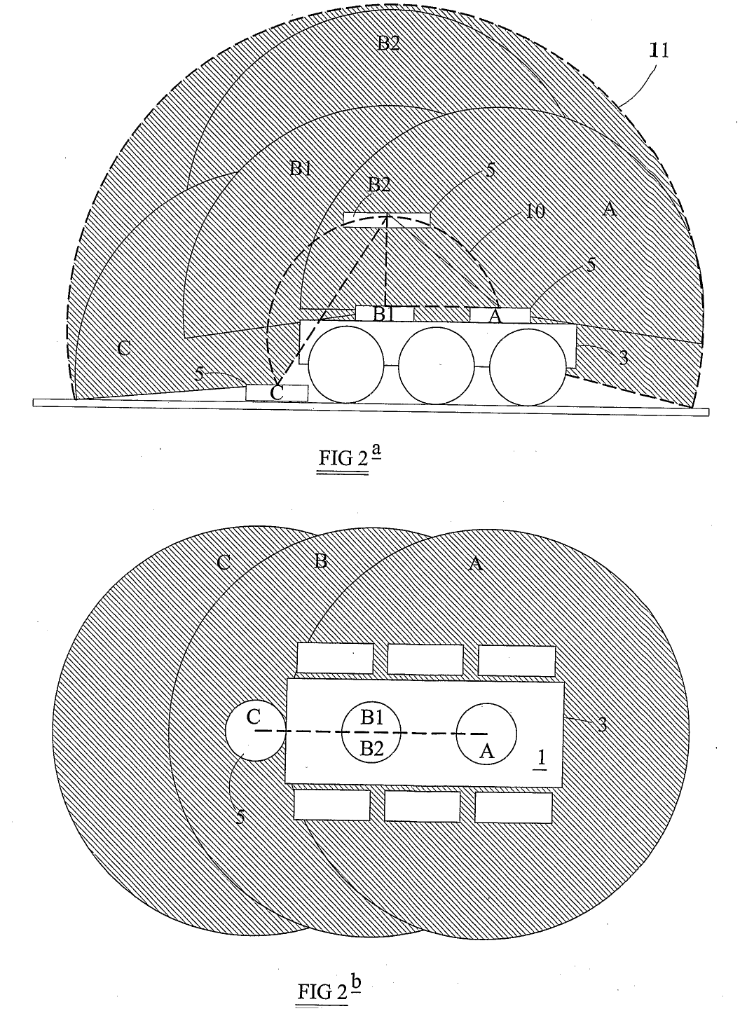

FIGS. 2a and 2b show the operating reach of a manipulator arm of a remotely operable machine according to the present invention;

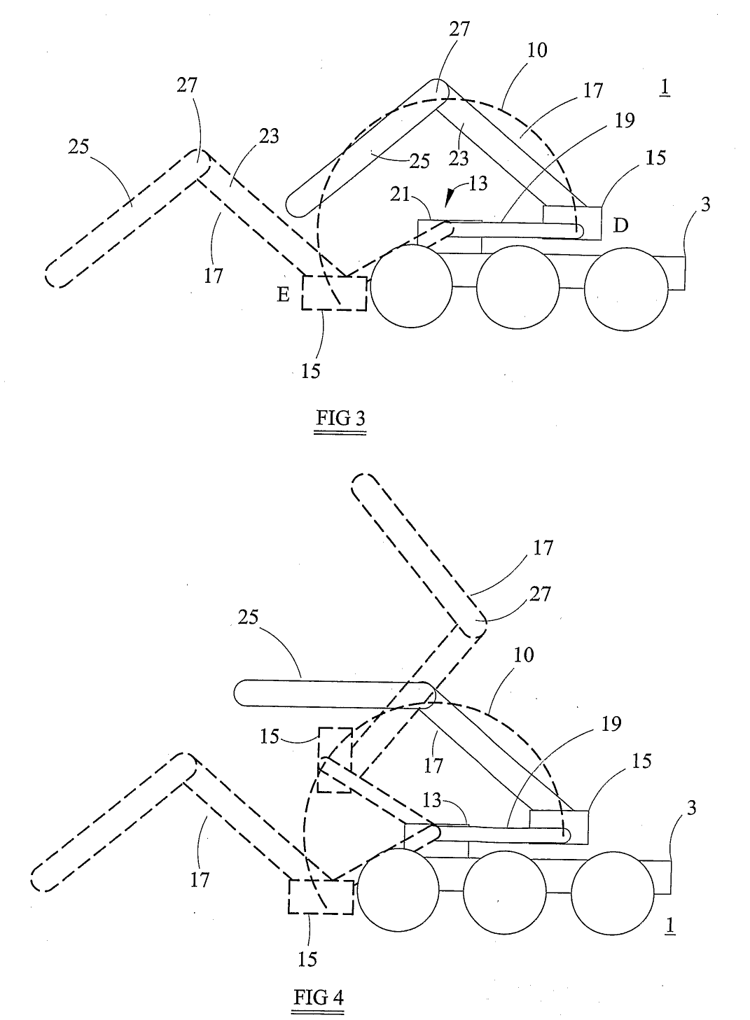

FIGS. 3 and 4 are schematic drawings of a remotely operable machine of a first embodiment, showing respectively different deployment positions of the manipulator arm;

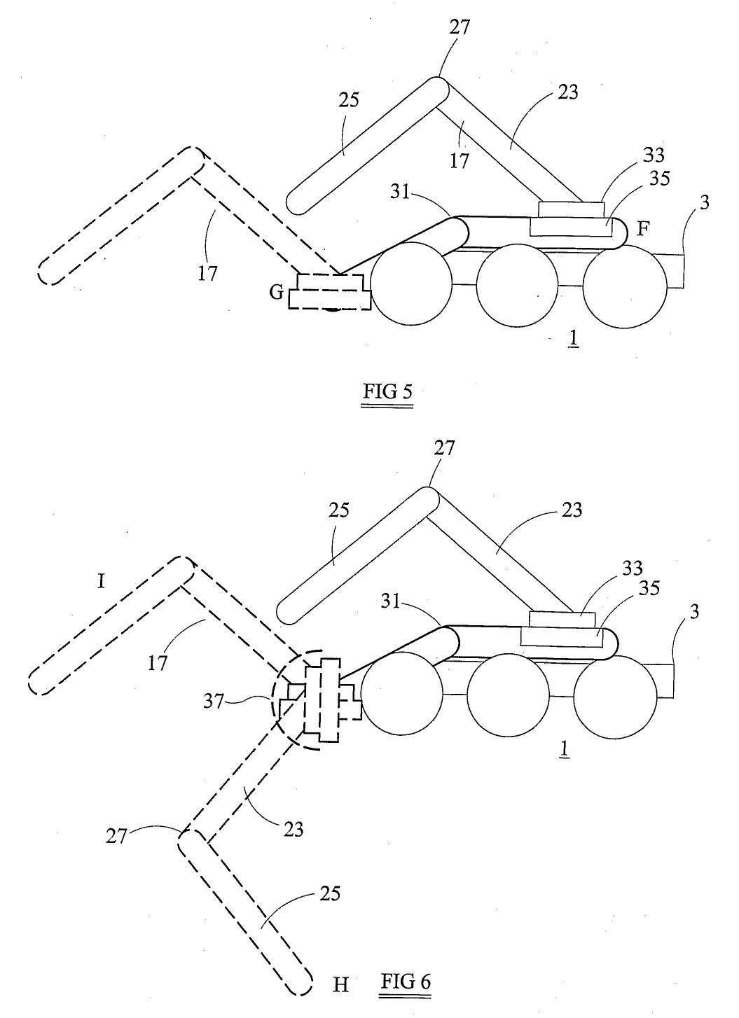

FIGS. 5 and 6 are schematic drawings of a remotely operable machine of a second embodiment, showing respectively different deployment positions of the manipulator arm;

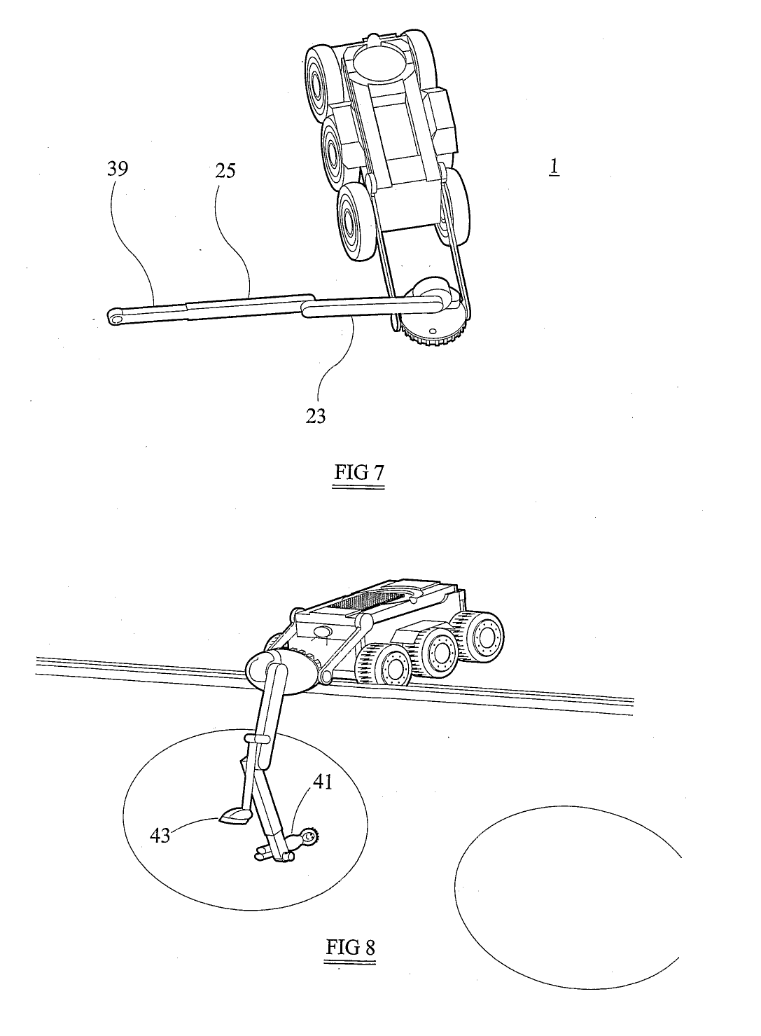

FIG. 7 is a perspective view of a remotely operable machine similar to the first embodiment of FIGS. 3 and 4;

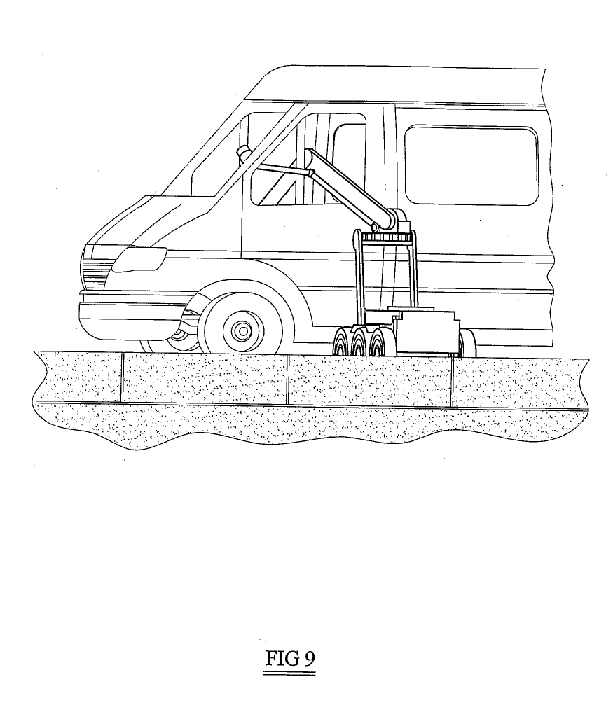

FIG. 8 is a drawing showing a possible deployment of the first embodiment; and

FIG. 9 is a drawing showing another possible deployment of the first embodiment.

FIG. 1a shows a remotely operable machine, illustrated generally by reference numeral 1. The machine 1 has a body 3 to which a support 5 is attached in a central region thereof. A manipulator arm (not shown) is pivotally and rotationally attached at one end to the support. A shaded area 7 shows the vertical operating reach of the manipulator arm achievable using this fixed mounting. Essentially, the reach is limited to an arc having a radius corresponding to the maximum length of the manipulator arm from the point of mounting of the arm on the machine.

FIG. 1b shows, as a shaded area 9, the horizontal operating reach of the machine 1 of FIG. 1. The manipulator arm is attached to a turntable arrangement (not shown) provided on the support 5 for facilitating rotation of the arm through 360 degrees about a vertical axis.

FIG. 2a shows, as four shaded areas A, B1, B2 and C, the operating reach in the vertical plane for the manipulator arm for four corresponding locations A, B1, B2 and C of the support 5. In this embodiment of the invention, the support 5 may be moved between the four locations through an arc 10, as well as intermediate positions, so that the manipulator arm can be moved through the arcs shown, including any position within the overall envelope 11. The support 5 may be moved vertically between positions B1 and B2. FIG. 2b is a plan view of the ‘deployment arcs’ (A, B and C) showing the horizontal operating reach of the manipulator arm. The rotational movement of the manipulator arm about the support 5 provided by the turntable arrangement facilitates this. In this view, shaded areas B1 and B2 are coincident. A schematic illustration of the remotely operable machine according to the first and second embodiments, showing how the support may be moved between these positions, will be described with reference to FIGS. 3 to 9 below.

In FIG. 3, the support 5 of the remotely operable machine 1 comprises a linkage depicted generally by reference numeral 13. The linkage 13 comprises an attachment 15 for pivotally supporting one end of a manipulator arm depicted generally by numeral 17. The body 3 of the remotely operated machine 1 by way of an extension arm 19 supports the attachment 15. The extension arm 19 is pivotally coupled to the attachment 15 at one end and pivotally coupled to a main body support 21 at its other end. The main body support 21 is fixed to the body 3 but is provided with a drive (not shown) for rotating the extension arm 19 such that the attachment 15 may be positioned at points along the arc 10. As a consequence, the manipulator arm 17 can be bodily moved between the positions shown at respective ends D and E of the arc 10 of FIG. 3 so that the operational reach of the end of the arm 17 remote from the attachment 15 is extended relative to the prior art. When in position D, the attachment 15 may be secured by a locking mechanism (not shown) when the machine is parked so that the load manipulating capacity of the arm 17 can be increased. When the machine 1 is parked, latches (not shown) may secure the attachment 15 or retaining pins in order to maximise the load manipulating capacity of the associated manipulator arm 17. When in the position E (shown in dotted outline in FIG. 3), the attachment is resting on the ground level although may rest on another stable surface depending on the operating environment. Furthermore, the attachment 15 may incorporate a rotational means to enable manipulator arm deployment at angles above or below the horizontal (as described further below in relation to FIGS. 5 & 6).

In these cases a stabilising means (not shown) may be provided for improving the load manipulating capacity. When any securing means is released, the manipulator arm 17 may be rotated to any operating position within its available arc of travel.

The manipulator arm 17 comprises a pair of arm members 23 and 25 articulated with respect to one another about a joint 27. The angle between the arm members 23 and 25 as well as the pivotal angle of the member 23 with respect to the attachment 15 is adjustable by a drive mechanism (not shown). The end of the arm member 25 remote from the pivot 27 may be provided with a tool (not shown) such as a gripping device or sensor and the orientation of this relative to the arm member 25 is also adjustable by the drive mechanism.

The drive mechanism for rotating and pivoting the manipulator arm 17 may be a motor & gearbox, hydraulic, or other mechanical system.

FIG. 4 corresponds to FIG. 3 but shows an intermediate positioning, in dotted outline, of the attachment 15, extension arm 19 and manipulator arm 17. In this position, the manipulator arm 17 can be extended for further vertical reach.

FIG. 5 shows an alternative embodiment of the invention in which a track assembly 31 is provided for facilitating movement of the manipulator arm 17 relative to the body 3. An turntable 33 provides pivotal and rotational support for the manipulator arm 17. The pivotal support is about a horizontal axis and the rotational support is 360 degrees about a vertical axis. The turntable 33 is mounted on a carriage 35, which is movable on the track assembly 31 between positions F and G. The track assembly 31 includes a track or guide mounted on the body 3. The movement of the turntable 33 and carriage 35 can be achieved by a drive in the form of a motor and gearbox, hydraulic or other mechanical system (not shown). The track assembly 31 is configured to extend close to the ground level so that the support and carriage can be moved to ground level as shown in position G. As in the case of the first embodiment, a stabilising means may be provided for increasing load capacity.

As illustrated in dotted outline in FIG. 6, the turntable 33 and carriage 35 is provided with a joint that facilitates rotation of the manipulator arm 17 about an axis extending perpendicular to the plane of the drawing of FIG. 6. This is so that the manipulator arm 17 can be deployed at angles above or below the horizontal surface on which the machine is standing. The machine is therefore capable of orientating the tool or sensor of the manipulator arm 17 to positions that would allow inspection or access to a culvert below the standing level of the machine (as indicated by H). The turntable 33 and carriage 35 can therefore be rotated through an arc of rotation indicated by the dotted line 37. FIG. 6 also shows in dotted outline the manipulator arm 17 deployed in an intermediate position (I). The attachment 15 of the first embodiment described with reference to FIGS. 3 and 4 may be similarly provided with a rotatable joint for facilitating deployment of the arm to positions below the level of the machine.

In the embodiments shown, the machine 1 is illustrated with wheeled drive means. It will be apparent to those skilled in the art that tracked or other drive means may be employed in similar embodiments.

FIG. 7 shows a modified form of machine relative to the first embodiment described above. In this embodiment, the manipulator arm member 25 is comprises a telescopic member 39, which provides for further extension of the reach of the arm.

FIG. 8 illustrates how the embodiment of FIG. 7 can be used to inspect a culvert below road level. In this case, a gripping claw 41 is provided at the remote end of the arm 17 and a separate sensor or video camera is provided at the end of an articulated sensor arm 43, which is mounted to the attachment 15.

FIG. 9 is another example of how the embodiment of FIGS. 7 and 8 may be deployed.

1. A remotely operable machine comprising a manipulator arm, a machine body, and a support disposed between said machine body and said manipulator arm for coupling said arm to said body, wherein said support is movable from one position to another relative to said body so as to provide for variation or extension of the reach of the manipulator arm.

2. A remotely operable machine according to claim 1, wherein the support comprises a linkage having an attachment for pivotally supporting the arm, the attachment being pivotally coupled to an extension arm at one end thereof, the extension arm being pivotally coupled to the machine body at its other end.

3. A remotely operable machine according to claim 2, comprising a locking mechanism for securing the attachment when the machine is parked so that the load manipulating capacity of the arm can be increased.

4. A remotely operable machine according to claim 2, comprising a drive for rotating said extension arm relative to the pivot at the machine body such that the position of the end of the arm supported by the attachment can be deployed at selectable positions along an arc having a radius defined substantially by the length of the extension arm.

5. A remotely operable machine according to claim 2, wherein the coupling position and configuration of the extension arm to the machine body is such that the attachment is positionable to rest on the ground adjacent to the machine body.

6. A remotely operable machine according to claim 5, wherein a stabiliser is provided for improving the load manipulating capacity when the attachment is deployed on the ground.

7. A remotely operable machine according to claim 1, comprising a track assembly for facilitating movement of the support on said body.

8. A remotely operable machine according to claim 7, wherein the track assembly is configured to allow deployment of the support on the ground adjacent to said body.

9. A remotely operable machine according to claim 7, wherein the track assembly comprises a carriage for the support movably mounted on a guide or track.

10. A remotely operable machine according to claim 9, wherein the guide or track is mounted on the machine body.

11. A remotely operable machine according to claim 9, comprising a drive for moving the carriage along the guide.

12. A remotely operable machine according to claim 1, wherein the manipulator arm is provided with a tool and/or sensor at the end thereof remote from the support.

13. A remotely operable machine according to claim 11, wherein the manipulator arm is provided with one or more articulations and/or telescopic sections that facilitate a radial degree of movement of the tool of the manipulator arm relative from the support.

14. A remotely operable machine according to claim 1, wherein the support is configured to provide for movement of said manipulator arm in a horizontal plane about a vertical axis.

15. A remotely operable machine according to claim 1, wherein the support provides for movement of said manipulator arm in a vertical plane about a horizontal axis.

16. A manipulator arm for a remotely operable machine having a machine body, the manipulator arm having an attachment for facilitating coupling thereof to the machine body so that the manipulator arm is movable relative to the machine body in order to allow variation or extension of the reach of the arm.

17. A body of a remotely operable machine having a machine body, the body being configured to facilitate coupling thereto of a manipulator arm attachment such that said manipulator arm attachment is movable relative to said body in order that the reach of a manipulator arm coupled to said attachment can be varied or extended
